(19) United States
(12) Patent Application Publication
(10) Pub. No.: US 2013/0018921 A1
(43) Pub. Date: Jan. 17, 2013

(54) NEED-TO-KNOW INFORMATION ACCESS USING QUANTIFIED RISK

(71) Applicants: Hongxia JIN, San Jose, CA (US); Qihua WANG, San Jose, CA (US)

(72) Inventors: Hongxia JIN, San Jose, CA (US); Qihua WANG, San Jose, CA (US)

(73) Assignee: INTERNATIONAL BUSINESS MACHINES CORPORATION, Armonk, NY (US)

(21) Appl. No.: 13/182,317

(22) Filed: Jul. 13, 2011

(51) Int. Cl. G06F 7/00; G06F 17/00

(52) U.S. Cl. 707/784; 707/E17.001

(57) ABSTRACT

Embodiments of the invention related to access control to sensitive data records, and in particular need-to-know information access using quantified risk. In one aspect of the invention access control includes retrieving a list of accesses to data by a plurality of users for a certain purpose during a specified period of time. The access patterns are derived based on said accesses and the derived access patterns are stored. A risk score is computed, for each of the plurality of users based on each of the plurality of users' need to access the data for said certain purpose, and the risk scores are stored. An aggregated total risk score for each of the plurality of users is created based on each respective user's computed risk score in a specified number of recent periods of time. A risk tolerance threshold is determined based on the aggregated total risk score for each of the plurality of users. A warning is issued if the aggregated total risk score for any of the plurality of users exceeds a risk-tolerance threshold.

### BACKGROUND

The present invention relates generally to the field of access control management and more specifically to access control to sensitive data records.

Organizations collect and generate large amounts of data that can be used by many different parties for various purposes. Hospitals may generate medical records that could potentially be used by insurance companies and other entities. Part or all of the data may be sensitive and may require that the information be shared only as necessary. However, it is oftentimes difficult to determine what kinds of medical information are necessary to an entity in different scenarios. In particular, in an emergency, exceptions on information access may need to be made.

### BRIEF SUMMARY

One aspect of the invention includes a method for access control. The method includes retrieving a list of accesses to data by a plurality of users for a certain purpose during a specified period of time; deriving access patterns based on said accesses; storing the derived access patterns; computing a risk score for each of the plurality of users based on each of the plurality of users' need to access the data for said certain purpose; storing the risk scores; creating an aggregated total risk score for each of the plurality of users based on each respective user's computed risk score in a specified number of recent periods of time; determining a risk tolerance threshold based on the aggregated total risk score for each of the plurality of users; and if the aggregated total risk score for any of the plurality of users exceeds a risk-tolerance threshold, issuing a warning.

Another aspect of the invention includes a method for access control. The method includes retrieving a list of accesses of data by a plurality of users; deriving patterns of accessing the data by each of the plurality of users; storing the derived access patterns; allowing a quota specified as a limited number of accesses to the data by each of the plurality of users based on all of the plurality of users' risk scores; computing a risk score for each of the plurality of users based on each of the plurality of users' need to access the data for said certain purpose; updating a remaining balance of allowed accesses after each access of the data by each of the plurality of users, or after a number of accesses of the data by each of the plurality of users within a specified period of time; and if the remaining balance is negative, denying future access requests to the respective user.

Another aspect of the invention includes a computer program product for access control. The computer program product includes a computer program product including a computer readable storage medium having computer readable code embodied therewith, the computer readable program code comprising computer readable program code configured to retrieve a list of accesses of data by a plurality of users; computer readable program code configured to derive patterns of accessing the data by each of the plurality of users; computer readable program code configured to store the derived access patterns; computer readable program code configured to allow a quota specified as a limited number of accesses to the data by each of the plurality of users based on all of the plurality of users' risk scores; computer readable program code configured to compute a risk score for each of the plurality of users based on each of the plurality of users' need to access the data for said certain purpose; computer readable program code configured to update a remaining balance of allowed accesses after each access of the data by each of the plurality of users, or after a number of accesses of the data by each of the plurality of users within a specified period of time; and computer readable program code configured to, if the remaining balance is negative, deny future access requests to the respective user.

Another aspect of the invention includes a computer program product for access control. The computer program product includes a computer program product including a computer readable storage medium having computer readable code embodied therewith, the computer readable program code comprising computer readable program code configured to derive a first pattern of accessing specified resources by a plurality of users for a certain purpose; computer readable program code configured to derive a second pattern of assessing the specified resources by a single user for the certain purpose; computer readable program code configured to measure a first entropy comprising a probability of an occurrence of the first pattern; computer readable program code configured to measure a second entropy comprising a probability of an occurrence of the second pattern; computer readable program code that equates information gain with the second entropy subtracted by the first entropy; and computer readable program code configured to compute a risk score for one of the users based on the information gain.

The above and below advantages and features are of representative embodiments only, and are not exhaustive and/or exclusive. They are presented to assist in understanding the invention. It should be understood that they are not to be considered limitations on the invention as defined by the claims, or limitations on equivalents to the claims. Additional features and advantages of the invention will become apparent in the following description, from the drawings, and from the claims. These and other features, aspects and advantages of the present invention will become better understood with reference to the following drawings, description and claims.

### BRIEF DESCRIPTION OF THE SEVERAL VIEWS OF THE DRAWINGS

FIG. 1 is a block diagram of a system with an access control engine according to one exemplary embodiment of the invention;

FIG. 2 is a flowchart of a method for access control using the system of FIG. 1;

FIG. 3 is a flowchart of computing a risk score of a user's access pattern using the system of FIG. 1;

FIG. 4 is a flowchart for determining if a patient's medical record has been over-accessed using the system of FIG. 1;

FIG. 5 is a flowchart of an exemplary embodiment of the invention computing a risk score using the system of FIG. 1;

FIG. 6 is a flowchart showing an access control engine using the system of FIG. 1.

### DETAILED DESCRIPTION

The present invention incorporates a risk-adaptive access control solution in ways not heretofore available including dynamic evaluation of a person's risk for accessing sensitive information, such as assessing medical records.

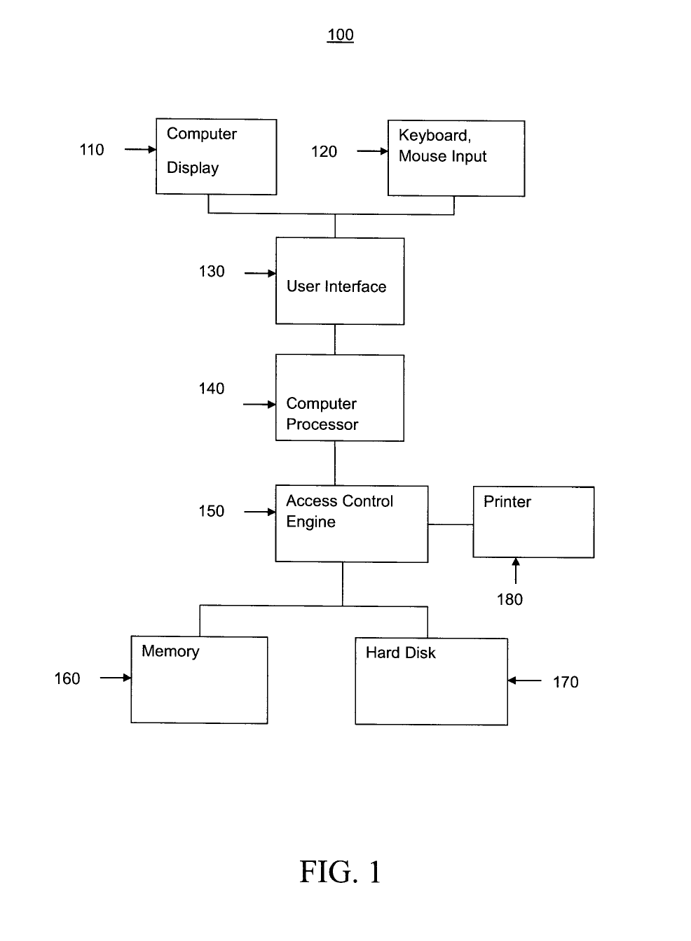

FIG. 1 is a block diagram of a system 100 according to an exemplary embodiment of the invention. The system 100 may include a computer display 110, a keyboard and mouse 120, a user interface 130, a computer processor 140, an access control engine 150, memory 160, a hard disk 170, and a printer 180.

A user may utilize the invention by operating the user interface 130 with the keyboard and mouse 120. The user may utilize the system 100 by inputting data and instructions from the user interface 130 for processing by the access control engine 150. The access control engine may be processed by a computer with a computer processor 140. The user interface 130 and the access control engine 150 may be stored in computer memory, for example, random access memory 160 and on a hard disk 170. The user may also print operations from the user interface 130 on the printer 180.

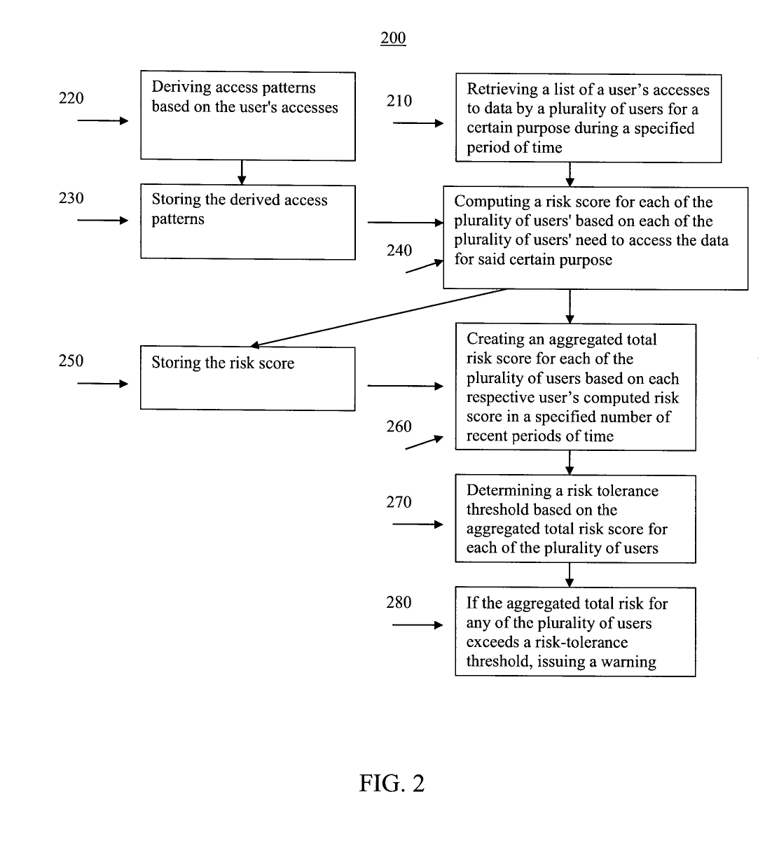

As shown in FIG. 2, an exemplary method 200 for determining whether a user has over-accessed patient records may include a step 210 of retrieving a list of a user's accesses to data by a plurality of users for a certain purpose during a specified period of time. For example, a purpose for a user access may be for reviewing patient records in order to diagnose a patient's symptoms. A step 220 may include deriving access patterns based on the user's accesses to data. For example, deriving an access pattern from activities of all users may include reviewing a stored database list of accesses by all users of a patient's medical records for a certain purpose. As an example, deriving an access pattern may include deriving a distribution of roles of users who accessed specific resources in a category of a certain medical record in a certain time period. A step 230 may include storing the derived access patterns in a second database.

As further described in FIG. 2, a step 240 may include computing a risk score for each of the users based on each of the users' need to access the data for a certain purpose. For example, computation of the risk score may include determining the user's need for specific medical records. A step 250 may include storing the risk score in a third database. A step 260 may include creating an aggregated total risk for each of the users based on the respective user's computed risk score in a specified number of recent time periods. For example, creating an aggregated total risk of a user may include combining the risk scores of the user for each of the recent time periods. A step 270 may include determining a risk-tolerance threshold based on the aggregated total risk score for each of the plurality of users. For example, a risk-tolerance threshold may be determined as the 90 percentile of the users' aggregated risks. A step 280 may include issuing a warning if any of the users' aggregated risk exceeds the risk-tolerance threshold.

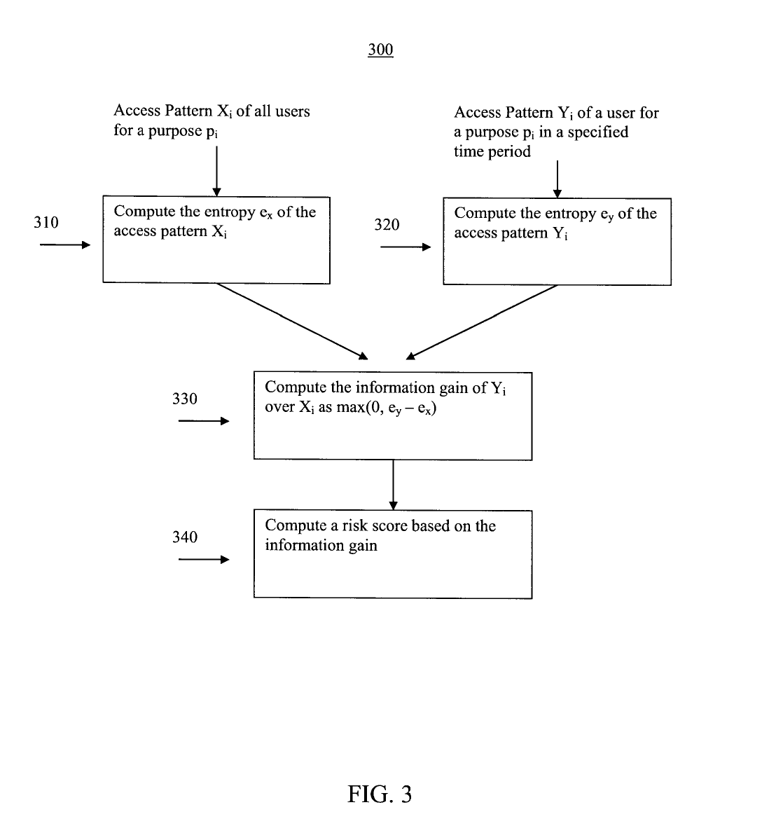

As shown in FIG. 3, an exemplary method of computing a risk score 300 may include a step 310 of computing an entropy eₓ of an access pattern Xᵢ after receiving an access pattern Xᵢ of all users for a purpose pᵢ. For example, computing an entropy eₓ may include computing a probability of access pattern Xᵢ occurring. A step 320 may include computing an entropy e_{y} of an access pattern Yᵢ after receiving access pattern Yᵢ of a user for a purpose pᵢ in a specified time period. For example, computing the entropy e_{y} of the access pattern Yᵢ may comprise computing a probability of the access pattern Yᵢ occurring. A step 330 may include computing an information gain of Yᵢ over Xᵢ as max(0, e_{y}−eₓ). For example, an information gain of access pattern Yᵢ over access pattern Xᵢ may be the maximum of zero and the difference of the entropies e_{y} and eₓ. A step 340 may include computing a risk score for a user based on the information gain.

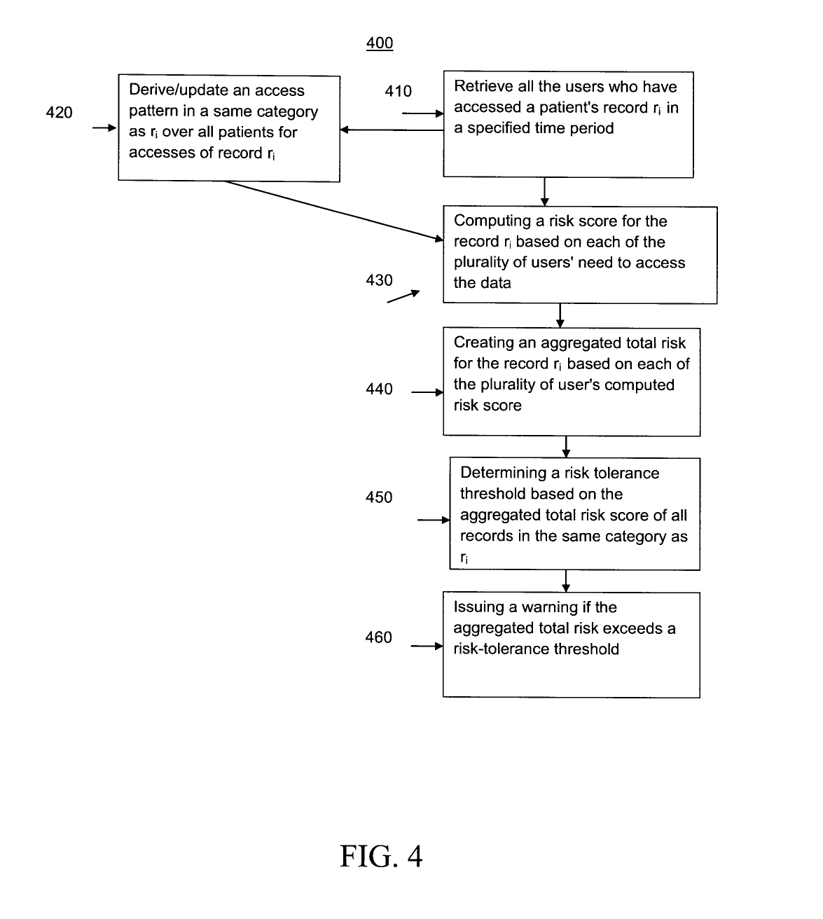

As shown in FIG. 4, detecting whether a patient's medical record has been over-accessed 400 may include a step of 410 retrieving all users who have accessed a patient's record rᵢ in a specified time period. For example, all persons who have accessed a specific record of a patient in a year may be retrieved. A step 420 may include deriving and updating a user's access pattern for records in the same category as rᵢ over all patients from access activities in, for example, a group of databases. For example, a derivation of a user pattern of medical record accesses in the category of lab results may be computed. The results of the derivation may then be used to update the records of the person's history of record accesses. As an example, access patterns may include deriving access patterns of a particular person for records of various patients in a specified group of databases.

As further shown in FIG. 4, a step 430 may include computing a risk score for the record rᵢ based on each of the plurality of users' need to access the data. For example, a risk score for the record rᵢ may be computed based on probabilities of a user having a specified access pattern of the specified record rᵢ. A step 440 may include creating an aggregated risk for the record rᵢ based on each of the plurality of users' computed risk score. For example, creating the aggregated risk for the record rᵢ may include retrieving the history of accesses for the record rᵢ. A step 450 may include determining a risk-tolerance threshold based on aggregated risk of all records in the same category as record rᵢ. A risk tolerance threshold may be, for example, an average number of accesses for records in the same category. As an example, determining risk tolerance may include determining the risk tolerance based on an aggregated risk for each of the users with a specified job title. A step 460 may include issuing a warning if an aggregated risk exceeds the determined risk-tolerance threshold.

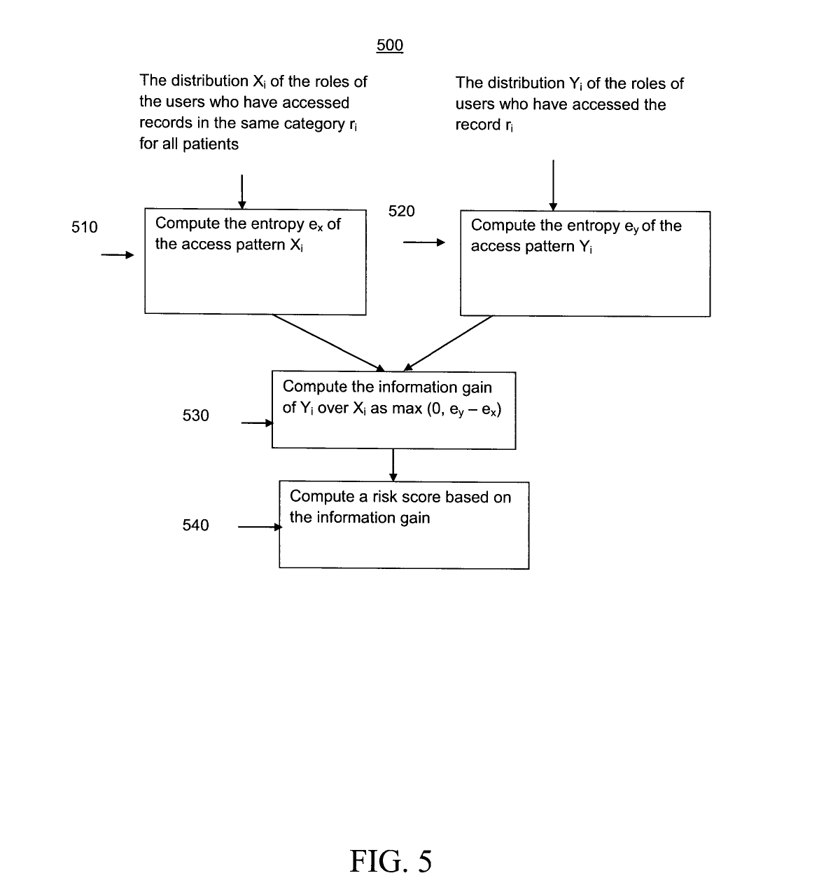

As shown in FIG. 5, an exemplary method of computing a risk score 500 for a user pattern on a certain record over a specified period of time may include a step 510 of computing an entropy eₓ of an user pattern Xᵢ. The entropy eₓ of the user pattern Xᵢ may, for example, be computed based upon a distribution Xᵢ of roles of users who have been involved in access activities for records in a same category as record rᵢ for all patients. A step 520 may include computing an entropy e_{y} of a user pattern Yᵢ. The entropy e_{y} of user pattern Yᵢ may, for example, be computed based upon a distribution Yi of roles of users who have accessed record rᵢ in a specified time period. A step 530 may include computing an information gain of Yᵢ over Xᵢ as max(0, e_{y}−eₓ). A step 540 may include computing a risk score for a user based on the information gain.

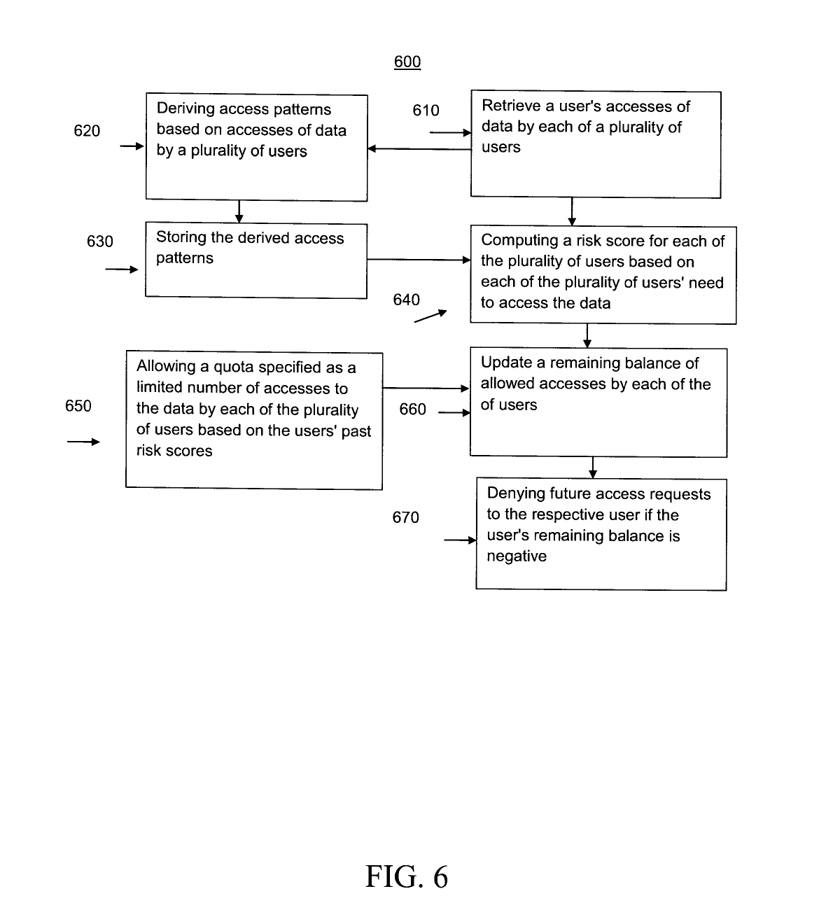

As shown in FIG. 6, an access control engine 600 may include a step of 610 retrieving a user's accesses of data by each of a plurality of users. For example, a user may derive a pattern of accessing specified resources for all users for a certain purpose. A user may derive a second pattern for assessing specified resources for a single user for the certain purpose. A step 620 may include deriving access patterns based on accesses of data by the plurality of users. A step 630 may include storing the derived access patterns. As an example, databases may be automatically updated after a change to at least one database. For example, after a user's accesses to records in a database are examined, the user's stored pattern of accesses may be updated.

As further shown in FIG. 6, a step 640 may include computing a risk score for each of the users based on need to access data for the certain purpose. The need to access data may be enforced by quantitatively measuring relevancy of an access request against a reason for the access request. The need to access data may further be enforced based on access history of a user. For example, the risk score may be based on probabilities of a user in a certain role accessing a medical record of a certain type for a certain purpose. A step 650 may include allowing an access quota specified as a limited number of accesses to the data, for example, on a periodic basis, to a user based on the user's risk scores. For example, a medical doctor's regular need for medical records of a certain type may require a periodic granting of a quota of medical record accesses to the medical doctor. A step 660 may include updating a remaining access quota balance for the user based on the risk score computed at step 640. For example, after a user accesses a medical record, the user's remaining quota balance number of allowed record accesses may be reduced by an amount that is proportional to the risk score of the user's access of the medical record.

As further shown in FIG. 6, a step 670 may include denying future access requests from the user if the quota balance becomes negative. For example, if a user uses up the user's quota of accesses to a database for a specified time period, the user's outstanding balance amount of remaining accesses allowed may be increased. If the user's account balance is negative, the user may have performed more accesses of records than the user's quota allotment. If the user has not used up the user's quota of accesses to the database, then the user has a remaining balance of allowed accesses to the database. The user's quota of access to the database for a specified time period may be increased or decreased.

As an example, users may determine their information needs for accessing records, without the use of an administrator. An access request may include at least an identity of a requestor, purpose of the request, label of a target resource, and a timestamp. The access request may be stored and maintained on a computer storage medium. A purpose of the access request may be automatically calculated from the context of the access request, and user role in the access request. As an example, a higher risk score may be given to accessing specified resources within a specified time period, than to accessing the specified resources outside the specified time period.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable media having computer readable program code embodied thereon.

Any combination of one or more computer readable media may be utilized. A computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of computer readable storage media would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It should be understood, of course, that the foregoing relates to exemplary embodiments of the invention and that modifications may be made without departing from the spirit and scope of the invention as set forth in the following claims.

1-13. (canceled)

14. A computer product comprising:
a computer program product including a computer readable storage medium having computer readable code embodied therewith, the computer readable program code comprising
computer readable program code configured to retrieve a list of accesses of data by a plurality of users;
computer readable program code configured to derive patterns of accessing the data by each of the plurality of users;
computer readable program code configured to store the derived access patterns;
computer readable program code configured to allow a quota specified as a limited number of accesses to the data by each of the plurality of users based on all of the plurality of users' risk scores;
computer readable program code configured to compute a risk score for each of the plurality of users based on each of the plurality of users' need to access the data for said certain purpose;
computer readable program code configured to update a remaining balance of allowed accesses after each access of the data by each of the plurality of users, or after a number of accesses of the data by each of the plurality of users within a specified period of time; and
computer readable program code configured to, if the remaining balance is negative, deny future access requests to the respective user.

15. A computer program product comprising:
a computer program product including a computer readable storage medium having computer readable code embodied therewith, the computer readable program code comprising
computer readable program code configured to derive a first pattern of accessing specified resources by a plurality of users for a certain purpose;
computer readable program code configured to derive a second pattern of assessing the specified resources by a single user for the certain purpose;
computer readable program code configured to measure a first entropy comprising a probability of an occurrence of the first pattern;
computer readable program code configured to measure a second entropy comprising a probability of an occurrence of the second pattern;
computer readable program code that equates information gain with the second entropy subtracted by the first entropy; and
computer readable program code configured to compute a risk score for one of the users based on the information gain.

16. The computer program product of claim 15, wherein deriving the first pattern includes deriving a distribution of roles of users who accessed the specified resources in the category of a certain record.

17. The computer program product of claim 16, wherein deriving the second pattern includes deriving a distribution of roles of users who have accessed the certain record in a specified time period.

18. The computer program product of claim 15, wherein computing a risk score includes determining a risk score from the difference of the first pattern and the second pattern.

19. The computer program product of claim 15, wherein a purpose of an access request by one of the users is automatically extracted from the context of the access request and from user role in the access request.

20. The computer program product of claim 15, wherein computing the risk score includes giving a higher risk value to accessing of the specified resources within a specified time period than to accessing of the specified resources outside the specified time period.
